(19) United States
(12) Patent Application Publication
(10) Pub. No.: US 2023/0088464 A1
(43) Pub. Date: Mar. 23, 2023

(54) DEVICE HARNESSING WAVE ENERGY TO PRODUCE ELECTRICAL ENERGY WITH AMPLIFICATION SYSTEM

(71) Applicant: ADVANCE THIRD AGE RENEWABLE ENERGY (ATAREC), Tanger (MA)

(72) Inventors: Oussama Nour, Aazib Lhaj Kaddour, Tanger (MA); Mohamed Taha EL OUARYACHI, Souani Il, Tanger (MA)

(21) Appl. No.: 17/796,167

(22) PCT Filed: Jan. 13, 2021
(86) PCT No.: PCT/MA2021/000001

§ 371 Date: Jul. 28, 2022

(30) Foreign Application Priority Data
Feb. 7, 2020 (MA) 48240

(51) Int. Cl. F03B 13/18

(52) U.S. Cl. CPC F03B 13/1855; F05B 2260/406

(57) ABSTRACT

The invention relates to a device that uses wave energy to convert it into electrical energy via hydraulic energy. This device is installed on marine structures with vertical walls and comprises: a free floating elementing element that exploits the vertical sea level variation due to the swell, guided by a triple rail lateral movement channeling system installed on vertical walls; a support connecting the floating elementing element to a hydraulic system of cylinders allows the conversion of mechanical energy into hydraulic energy in both directions of movement, up and down; an energy amplification system to optimize the efficiency of the device; a hydraulic power plant; pressure accumulators; an oil tank and a hydro-electric turbine that allow the conversion of hydraulic energy into electric energy.

### DOMAIN

The subject of the present description is a device designed to be attached to vertical dikes for maritime or port protection, allowing the production of energy, and more precisely to the field of electrical energy production from wave energy.

The field of the invention is the exploitation of wave energy, contained in the movement of the swell, i.e. from successive waves born from the effect of the wind on the surface of the sea and sometimes propagated over very long distances. There are different devices to exploit this energy. Many systems are currently being studied, some of which are already commercialized.

### STATE OF THE ART (CONTEXT)

Exploiting wave energy to create green electric power is a field undergoing extensive research worldwide.

For the technologies based on a floating elementing element, the nearest to the present invention vary between:
Those with a joint, which has a disadvantage of limiting the energy captured by going through the conversion of a rotation to a translation, which penalizes the performance of the solution, we take the example of the solution marketed under the name of Eco wave power, No. WO2013054326A8 or also the semi-submersible platform No. WO2014162096A1.
Those with a central piston, which requires a significant investment for the fixation of the piston on the seabed as well as the connection to the electrical network.

The problems that will be solved by our invention are:
The limitation of the operation due to low loads and storm conditions;
The electrical connection at sea for the systems which envisage an exploitation in remote offshore;
Anchoring, installation and accessibility in the marine environment;
The configuration of the device mitigating the absorption of all incident energy, passing through different forms of motion;
The significant cost of investment and maintenance;

The objectives of the present invention are:
To optimize the efficiency of transformation of wave energy into electrical energy;
Minimize the energy transformation chain by remaining in the same form of movement (translation);
Minimize the investment and operating costs;
Extend the operating range of the device depending on the wave conditions;
To control the fluctuation of the outgoing energy;
Ensure a green energy supply as close as possible to the port and maritime facilities;

### DETAILED DESCRIPTION OF THE INVENTION (IDENTIFICATION)

The device subject of the invention has the particularity to directly capture, through a free floating elementing element, the variation of the vertical sea level due to the swell, that is to say, it directly exploits the translation movements. By equipping the vertical dikes of maritime or harbour protection with this device, we benefit from the advantages of on-shore (accessibility, connection, shelters, low investment and maintenance costs) while being offshore (undamped swell—full energy in the vicinity of the vertical protection dikes). By controlling the interactions with the fixation elements, thanks to a triple rail system installed on the seawall wall, the device allows to enlarge the field of exploitation of the wave energy by going towards more important wave amplitudes.

The device is equipped with an amplification system allowing to channel the incident swells and to amplify the incident energy to the device which will optimize its performance and widen the operation periods.

The device is equipped with a self-balancing system based on the density distribution of the floating elementing element to limit the parasitic movements, as well as a ballasting system for total immersion in case of strong storm.

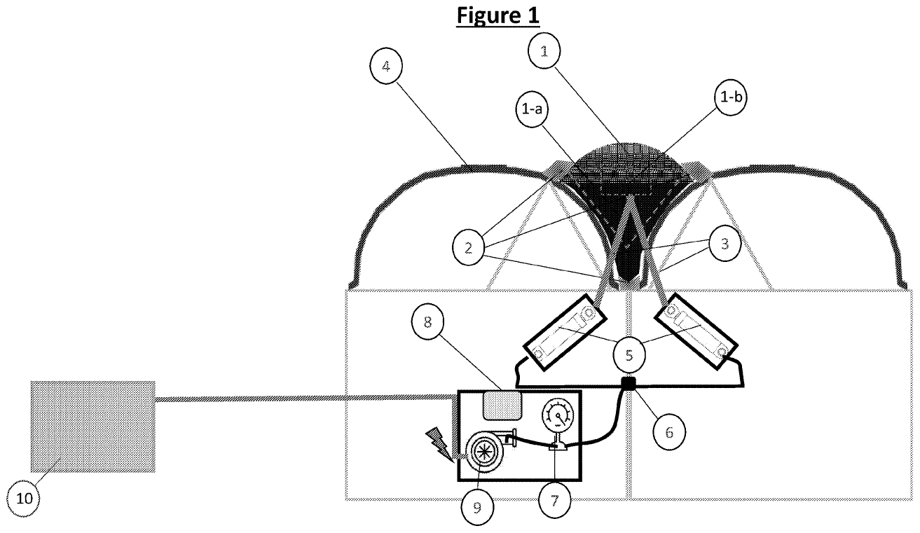

FIG. 1 shows a top view of the device installed on a vertical protection dike with amplification.

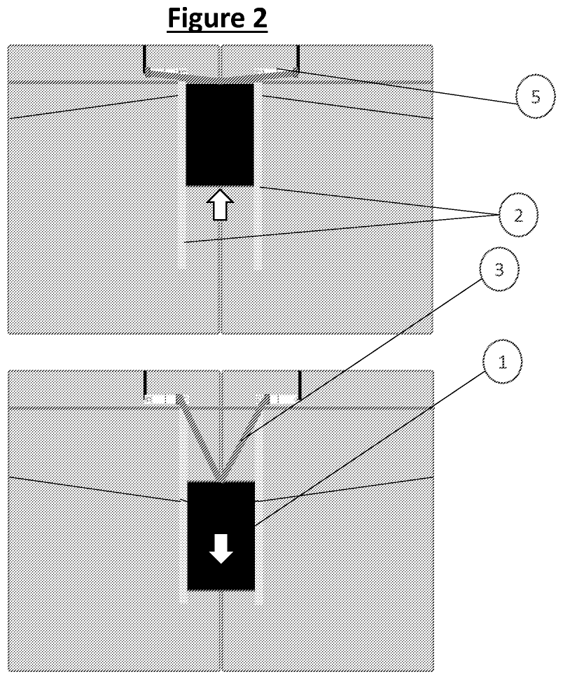

FIG. 2 shows a side view on the sea side of the device installed on a vertical protection dike with amplification.

The device is composed of a free floating elementing element (1) allowing to directly exploit the sea variation capturing the swell energy as potential energy. The floating elementing element has a minimum average density of 0.8 with a density after ballasting up to 1.05. This floating elementing element includes:
a self-balancing system (1-a) thanks to valves that control the filling of the chambers inside the floating elementing element to ensure a weight distribution that balances the variable overpressures of the variation of the sea level under the floating elementing element due to the swell amplification system (4).
an automatic ballasting system (1-b) allowing to drown the floating elementing element in case of storm or to raise the floating elementing element after the end of the storm

The floating elementing element (1) is guided by a lateral movement channeling system (2), with 3 rails taking advantage of the support and verticality of the caisson walls, to ensure horizontality and tracking of the upward/downward movement. The travel of the movement channelling system is designed to sweep all cases with exploitable swell energy. The exploitation of the walls allows to extend the operating range of the device to the important amplitudes of the swell. No contact between the wall of the vertical dikes and the floating elementing element (1) is allowed thanks to the movement channeling system (2).

A rigid support (3) connecting the floating elementing element to a hydraulic system of cylinders (5) allows to convert mechanical energy into hydraulic energy in both directions of movement, up and down, the support allows to convert a vertical translation into a horizontal translation of the pistons of the cylinders (5).

An energy amplification system (4) to optimize the efficiency of the device allowing to channel the energy of the swell thanks to inflatable structures supported on vertical flat wall caissons, the floating elementing element is placed in the middle zone of energy convergence, for the vertical dikes which presents this form of amplification, whether it is oblique or triangular, the device will benefit directly from this amplification without needing the amplification system (4).

Cylinders (5) that transform the mechanical energy into hydraulic energy, exploiting the two directions of movement, upward and downward.

A hydraulic unit (6) to manage the junctions and flows between the different cylinders.

Pressure accumulators (7) with controlled flow that receive variable hydraulic energy and transmit a continuous and uniform flow at the output with a capacity of up to 20 cycles of up and down movement (10 min maximum).

An oil tank (8) to ensure the continuity of the fluid chain, high pressure oil—low pressure oil that exits the turbine (9).

A hydro-electric turbine (9) to transform the flow of hydraulic energy into electrical energy.

A management interface (10) of output current and injection in the electrical network allowing a harmonization of voltage and frequency.

The sensitive components are housed in conditions of optimal durability.

This invention is exploitable in:
Port facilities: Protective dikes in caissons or vertical walls
Tourist facilities exposed to the sea: Vertical protection walls
Maritime developments with a vertical wall connection to the sea

Note that the shape of the vertical wall can be flat or other.

The objective is to revolutionize the role of port or maritime protection facilities, moving from hunting the swell to its exploitation to produce green energy.

1. A device exploiting energy of a swell to produce energy exploitable at output, through a mechanical-hydraulic and optionally electrical converter chain, the device comprising:
a free floating element which exploits variation of a vertical sea level due to the swell, guided by three lateral rails to guarantee vertical movement while allowing a degree of freedom in rotation of the free floating element around a horizontal axis perpendicular to a direction of the swell installed on vertical walls, the free floating element allows a ballasting to protect a system in case of storm, and a variable distribution of density by filling an inside of chambers;
a support connecting the free floating element to a hydraulic system of cylinders allows conversion of mechanical energy into hydraulic energy in directions of movement upward and downward;
an energy amplification system of the swell;
a hydraulic power plant; and
pressure accumulators, an oil tank and a hydro-electric turbine which allow conversion of the hydraulic energy into electrical energy.

2. The device exploiting the energy of the swell according to claim 1, in which the free floating element allows to directly exploit the vertical translation movements, which comprise variation of the water surface, capturing the energy of the swell in the form of potential energy during its downward movement and kinetic energy during its upward movement.

3. The device exploiting the energy of the swell according to claim 1, wherein the free floating element has a self-balancing system based on control of the filling of the inside of the chambers by controlled valves, and which allows to vary a density distribution of the free floating element, in order to adapt the density distribution of its weight to balance variable overpressures of the variation of the sea level under the free floating element due to the energy amplification system of the swell.

4. The device exploiting the energy of the swell according to claim 1, wherein the automatic ballasting system makes it possible to drown the free floating element in the event of a storm due to ballasting or to raise the free floating element after the end of the storm due to emptying or de-ballasting.

5. The device exploiting the energy of the swell according to claim 1, wherein a lateral movement channeling system, with 3 rails taking advantage of support and verticality of caisson walls, to ensure horizontality and tracking of upward and downward movement and allows a degree of freedom of rotation on an axis orthogonal to the direction of the swell amplified in the horizontal plane to avoid blocking.

6. The device exploiting the energy of the swell according to claim 1, wherein the position of an end of the support attached to the free floating element varies instantaneously according to a center of application of forces on the free floating element.

7. The device exploiting the energy of the swell according to claim 1, wherein the energy amplification system, is configured for exploiting removable bodies or an existing configuration of an infrastructure, which allow, via their geometric shape, the convergence of the incident swell from a mouth on a sea side towards the free floating element to have an amplified amplitude of the swell at the level of the free floating element.

8. The device exploiting the wave energy according to claim 1, which exploits wave amplification systems installed in the vertical walls for creating the electrical energy.

9. The device exploiting the wave energy according to claim 1, wherein the hydraulic system of cylinders transforms the wave energy, through the free floating element, into the hydraulic energy, exploiting the whole cycle, the directions of movement, ascending, through hydrostatic and hydrodynamic efforts, and descending through recovery of residual potential energy of the free floating element.

10. The device exploiting the energy of the swell according to claim 1, in which the pressure stored in the pressure accumulators, identical to that inside the cylinders, is servo-controlled as a function of the amplitude of the amplified incident swell, in order to control resisting force generated by the pressure in the cylinders, and thus the energy absorbed by the cylinders.
